(19) United States
(12) Patent Application Publication
(10) Pub. No.: US 2011/0154373 A1
(43) Pub. Date: Jun. 23, 2011

(54) AUTOMATIC MASH-UP APPARATUS AND METHOD

(75) Inventors: Hak-Cheol KIM, Daejeon (KR); Kyung-Ok Kim, Daejeon (KR); Chang-Rak Yoon, Daejeon (KR); Ki-Jung Lee, Yongin-si (KR); Jae-Chul Kim, Daejeon (KR); Yoon-Seop Chang, Daejeon (KR); Seong-Ho Lee, Daejeon (KR); Jae-Jun Yoo, Daejeon (KR); Sun-Rae Park, Daejeon (KR); Jong-Hyun Park, Daejeon (KR)

(73) Assignee: Electronics and Telecommunications Research Institute, Daejeon (KR)

(21) Appl. No.: 12/968,676

(22) Filed: Dec. 15, 2010

(30) Foreign Application Priority Data
Dec. 18, 2009 (KR) 10-2009-0126712
Apr. 29, 2010 (KR) 10-2010-0040123

(51) Int. Cl. G06F 9/54

(52) U.S. Cl. 719/320

(57) ABSTRACT

The present invention relates to an apparatus and a method for automatic mash-up, and more particularly, to an apparatus and a method for automatic mash-up for providing new services by combining previously constructed services providing an open application programming interface (API). The automatic mash-up apparatus according to an exemplary embodiment of the present invention includes: a mash-up execution unit executing a mash-up service comprised of two or more open applications; a service context inference engine unit inferring changes in service context of the mash-up service; and a mash-up management control unit reorganizing the mash-up service in accordance with an inference result of the service context inference engine unit.

### CROSS REFERENCE TO RELATED APPLICATIONS

This application claims priority to Korean Patent Application Nos. 10-2009-0126712 and 10-2010-0040123 filed on Dec. 18, 2009 and Apr. 29, 2010, respectively, the entire contents of which are herein incorporated by reference.

### BACKGROUND OF THE INVENTION

1. Field of the Invention

The present invention relates to an apparatus and a method for automatic mash-up, and more particularly, to an apparatus and a method for automatic mash-up for providing new services by combining previously constructed services providing an open application programming interface (API).

2. Description of the Related Art

In general, a mash-up combines and applies various different contents or services to create new services.

Since the mash-up uses various services constituted by other people, the new services can be easily configured when only a method of using opened services is known, as a result, additional cost to create the new services is very low.

However, since the mash-up utilizes the services constituted by other people, the mash-up is dependent on other services.

A mash-up user determines a service order and a service method by initially considering the relationship between related services for a predetermined service and combines services providing the open API and the mash-up service is given in accordance with a method configured by the user.

In this case, when service situation information is changed, as a result, a new service is added or deleted while a service constituted by predetermined resources included in the mash-up service initially configured by the user is provided, the user should directly reconfigure the new service.

### SUMMARY OF THE INVENTION

The present invention has been made in an effort to provide a context aware apparatus and a context aware method for automatic mash-up in which when a context of a mash-up service which is being presently provided is changed, a user needs not to directly configure a new service but a mash-up server which recognizes changes in the context of the mash-up service automatically configures and provides a new mash-up service by including new resources by retrieving resources or excluding unnecessary resources depending on the context as necessary.

The present invention has been made in another effort to provide an apparatus and a method for, when changes occur in a predetermined resource, providing a mash-up service by reflecting the changes.

An exemplary embodiment of the present invention provides an automatic mash-up apparatus that includes: a mash-up execution unit executing a mash-up service comprised of two or more open applications; a service context inference engine unit inferring changes in a service context of the mash-up service; and a mash-up management control unit reorganizing the mash-up service in accordance with an inference result of the service context inference engine unit.

Herein, the mash-up management control unit adds the corresponding service by using service metadata corresponding to each of the open applications when adding a new service to the mash-up service.

Another embodiment of the present invention provides an automatic mash-up method that includes: executing a mash-up service comprised of two or more open applications; inferring changes in a service context of the mash-up service; and reorganizing the mash-up service in accordance with the changes in the service context.

According to the embodiments of the present invention, in providing a mash-up service defined by a mash-up user, it is possible to automatically generate and provide a new mash-up service by including necessary resources or excluding unnecessary resources by reflecting current context of a mash-up service while the mash-up service is provided.

Therefore, since the mash-up service user automatically provided with a new mash-up service actively changed depending on a change in a service context of the mash-up service while using the mash-up service, the mash-up service needs not to directly reconfigure the mash-up service.

### BRIEF DESCRIPTION OF THE DRAWINGS

FIG. 1 is a diagram showing an entire configuration for a mash-up service according to an exemplary embodiment of the present invention;

FIG. 2 is a diagram showing one example of a mash-up apparatus shown in

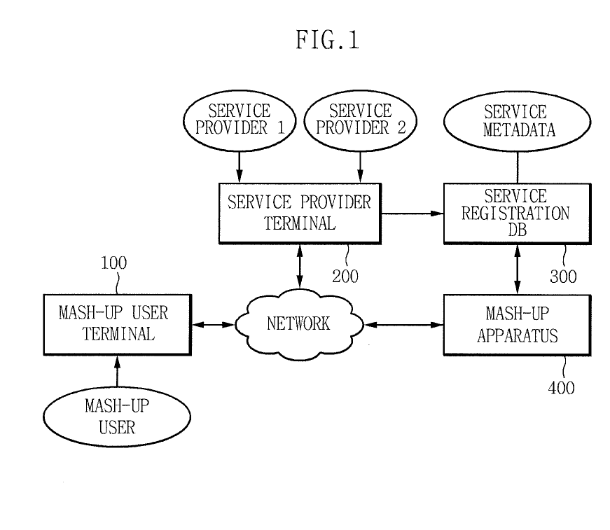

FIG. 1;

FIG. 3 is a diagram showing the flow of a mash-up method according to an exemplary embodiment of the present invention;

FIG. 4 is a diagram showing one example of reorganizing a mash-up service of FIG. 3; and

FIG. 5 is a diagram showing a use example of a mash-up method according to an exemplary embodiment of the present invention.

### DETAILED DESCRIPTION OF THE PREFERRED EMBODIMENTS

Hereinafter, a context aware method and a context aware apparatus for automatic mash-up according to an exemplary embodiment of the present invention will be described in detail with reference to the accompanying drawings.

FIG. 1 is a diagram showing an entire configuration for a mash-up service according to an exemplary embodiment of the present invention.

Referring to FIG. 1, the entire configuration of the mash-up service according to the present invention includes a service provider terminal 100, a user terminal 200, a service registration database (DB) 300, and a mash-up apparatus 400.

The mash-up user terminal 100 is connected to the mash-up apparatus 400 through a network and the user terminal 100 uses the mash-up service provided by the mash-up apparatus 400. The mash-up user terminal 100 provides an access environment capable of using the mash-up apparatus 400 to a mash-up user. For example, the mash-up user accesses the mash-up apparatus 400 (hereinafter, regarded as the same as the automatic mash-up apparatus disclosed in the appended claims) through the mash-up user terminal 100 and thereafter, uses the provided mash-up service.

The service provider terminal 200 serves to provide an open application, i.e., an open application programming interface (API). The service provider terminal 200 registers service metadata capable of using the open API in the service registration DB 300 to be described below. The service provider terminal 200 provides the access environment capable of using the service registration DB 200 to service providers including service provider 1, service provider 2, etc. Herein, the service providers provide open applications. Hereinafter, the open API disclosed in the present invention is one example of the open application.

The service registration DB 300 registers and manages the service metadata for using the open API provided by the service provider terminal 200. Herein, the service metadata may include a site address required to call the open API, a parameter required for calling, and additional information on the corresponding service. Further, the service metadata includes meta information which can retrieve a service on the basis of ontology. Herein, the meta information, as information used for general retrieval, can be easily appreciated by those skilled in the art on the basis of the prior art and as a result, a detailed description will be omitted.

The mash-up apparatus 400 executes the mash-up service configured by the mash-up user terminal 100, infers changes in a service context of the mash-up service, and automatically reorganizes the mash-up service according to the inference result. The mash-up apparatus 400 is connected to the network and preferably configured in a server form so as to provide the mash-up service and additional services, but it not limited thereto.

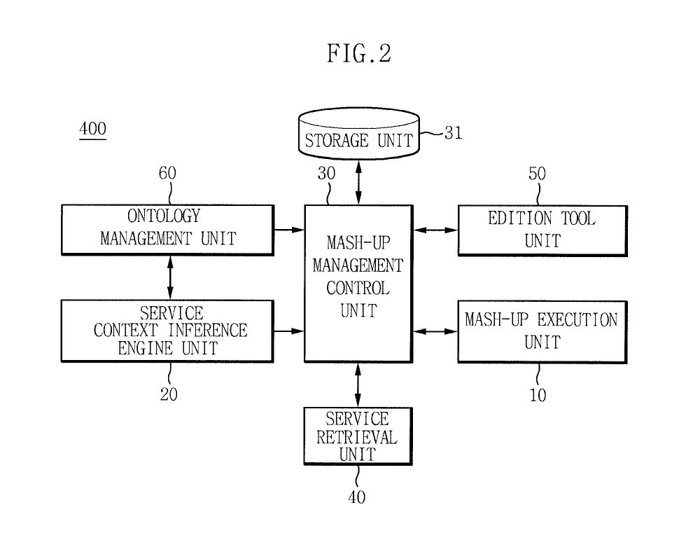

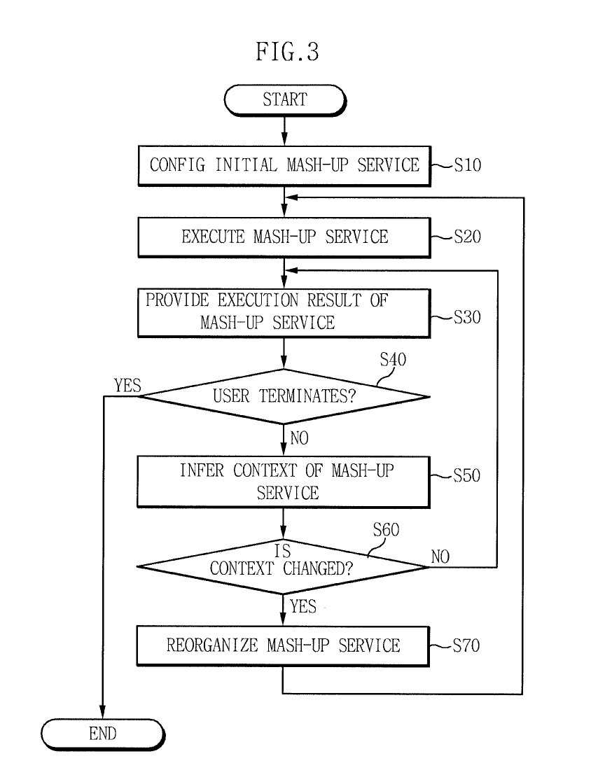

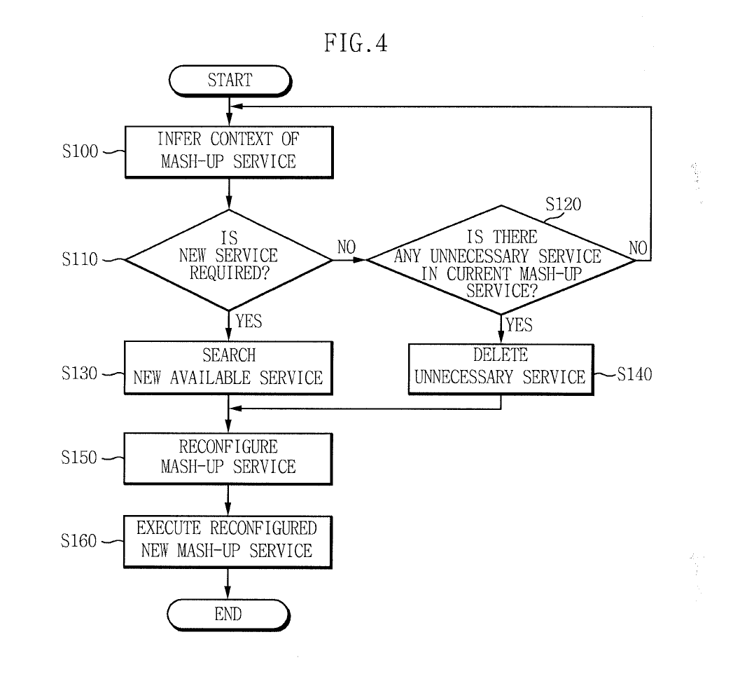

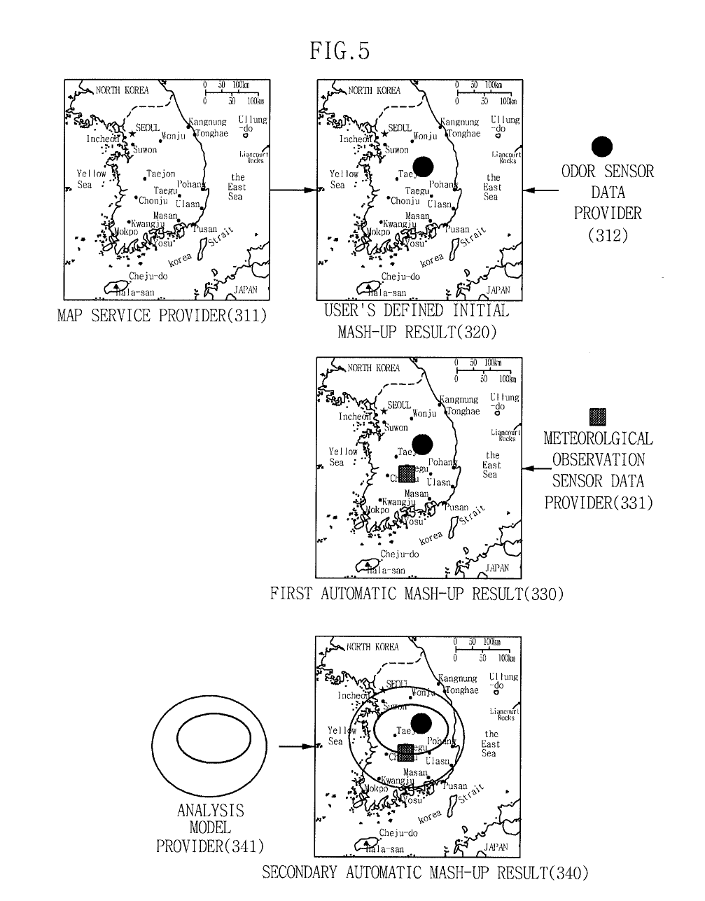

FIG. 2 is a diagram showing one example of a mash-up apparatus shown in FIG. 1.

Referring to FIG. 2, the mash-up apparatus 400 includes a mash-up execution unit 10, a service context inference engine unit 20, and a mash-up management control unit 30.

The mash-up execution unit 10 executes a mash-up service comprised of two or more open applications. As described above, the mash-up service according to the present invention previously configures the mash-up service to be used by the mash-up user terminal 100. In addition, the mash-up service includes the open application provided by the service provider terminal 200, e.g., the open application programming interface (API). Accordingly, the mash-up execution unit 10 calls and executes the open applications configured on the basis of the mash-up service. Further, the mash-up execution unit 10 executes the mash-up service and provides the execution result to the mash-up user. Since the method for executing the mash-up service can be easily appreciated by those skilled in the art in the prior art, detailed description will be omitted.

Further, in the present invention, the mash-up apparatus may further include an edition tool unit 50 capable of editing the configuration of the mash-up service. Therefore, the mash-up execution unit 10 executes the mash-up service by combining the open applications on the basis of the configuration of the edition tool unit 50. For example, the mash-up service edited by the mash-up user is stored in a storage unit 31. Further, the user may define the service context to be provided from the mash-up service configured in link with an ontology management unit 60 through the edition tool unit at the time of editing the mash-up service. The mash-up execution unit 10 executes the mash-up service by combining the services provided by the service providers including service provider 1, service provider 2, etc., on the basis of the configuration edited with the edition tool unit.

The service context inference engine unit 20 infers the changes in the service context of the mash-up service. The service context inference engine unit 20 infers the changes in the service context by using service context generated in the mash-up service while the mash-up service configured by the mash-up execution unit 10 is executed. For example, the service context inference engine unit 20 infers service context which is presently serviced on the basis of contents provided from predetermined resources constituting the mash-up service in real time and ontology provided by the ontology management unit 60 to be described below.

The mash-up management control unit 30 reorganizes the mash-up service in accordance with the inference result of the service context inference engine unit 20. The mash-up management control unit 30 manages the open applications constituting the mash-up service, that is, resource information and the relationship between resources. In addition, when changes occur in predetermined resource information, the mash-up management control unit 30 automatically recognizes the changes in accordance with the inference result of the service context inference engine unit 20 and updates the service context related to the corresponding resource. For example, the mash-up management control unit 30 automatically recognizes the changes in the service context which is presently serviced on the basis of ontology in accordance with the inference result of the service context inference engine unit 20 and automatically processes the recognized changes in service context.

Herein, the mash-up management control unit 30 adds the corresponding service by using service metadata corresponding to each open application when a service is required to the mash-up service. As described above, the service metadata may include a site address required to call the open API, a parameter required for calling, and additional information on the corresponding service. Further, as described above, the service metadata includes meta information which can retrieve a service on the basis of ontology.

The service metadata is previously registered in the service registration DB 300 by the service provider terminal 200.

Meanwhile, in the present invention, the mash-up apparatus may further include a service retrieval unit 40 retrieving the open applications corresponding to the service metadata. The service retrieval unit 40 retrieves and provides the corresponding open application by retrieving the service registration DB 300 on the basis of ontology at the time of a request from the mash-up management control unit 30. For example, the service context which is serviced on the basis of the current mash-up result is inferred on the basis of ontology and the service retrieval unit 40 retrieves the corresponding open application by searching the service registration DB 200 on the basis of service context ontology.

Therefore, when the mash-up management control unit 30 adds the service to the mash-up service, the mash-up management control unit 30 adds the corresponding open application retrieved through the service retrieval unit 40. For example, the mash-up management control unit 30 retrieves the corresponding service by using the service metadata of the service registration DB 200 through the service retrieval unit 40 and thereafter, automatically generates a new service by combining the corresponding service with the existing service. That is, when the mash-up management control unit 30 adds the mash-up service, the mash-up management control unit 30 retrieves service metadata corresponding to an open application to be added through the service retrieval unit 40 and registers the corresponding open application in a new mash-up service by using a site address or a parameter on the basis of the service metadata.

Further, when the mash-up management control unit 30 deletes the service from the mash-up service, the mash-up management control unit 30 may delete the corresponding open application. The mash-up management control unit 30 needs to exclude some of the services included in the current service in accordance with the service context inference result of the mash-up service, the mash-up management control unit 30 deletes the corresponding service, and automatically generates a new service and provides it to the user.

Meanwhile, in the present invention, the mash-up apparatus may further include an ontology management unit managing the ontology of the mash-up service.

Therefore, the service context inference engine unit 20 infers the changes in the service context on the basis of the execution result of the mash-up service in link with the ontology management unit 60 while the mash-up service is executed. That is, the service context inference engine unit 20 dynamically determines the resources constituting the mash-up service and the relationship between resource information in link with the ontology management unit 60 to infer the changes in the service context of the mash-up service. For example, it is assumed that service provider 1 (a map service) and service provider 2 (an odor sensor data providing service) are included in the initial mash-up service. In this case, the ontology management unit 60 manages ontology relating to an odor management service (that is, the intensity of the odor required to be managed and the intensity of the odor at a predetermined point is related to meteorological information (i.e., wind direction, wind speed, etc.)). When the service context inference engine unit 20 receives an odor intensity value that exceeds the intensity defined in the ontology from odor sensor data provided from service provider 2 in real time, the service context inference engine unit 20 determines the changes in the service context of the mash-up service. The service context inference engine unit 20 determines the changes in the service context and thereafter, determines that meteorological information is additionally required with respect to a situation serviced with the current mash-up result. The mash-up management control unit may generate the new service by automatically retrieving the service provider providing the meteorological information through the service retrieval unit.

Therefore, in the present invention, even when the service context of the service provided from the resources constituting the mash-up service is changed after configuring the initial mash-up service, it is possible to actively provide a requested mash-up service by minimizing user's intervention by reflecting the service context on the basis of service ontology.

FIG. 3 is a diagram showing the flow of a mash-up method according to an exemplary embodiment of the present invention.

First, an edition tool unit 50 edits an initial mash-up service to be executed (S10). For example, the edition tool unit 50 provides an edition environment capable of editing the mash-up service to a mash-up user terminal 100 accessing a network. In this case, a mash-up user configures the mash-up service by using the edition environment.

Thereafter, a mash-up execution unit 10 executes the initial mash-up service (S20) and provides an execution result (S30). Herein, a mash-up management control unit 30 stores the edited mash-up service. In this case, the mash-up execution unit 10 combines services provided by a service provider terminal 200 with each other on the basis of an edition result to execute the mash-up service. When the user terminates the mash-up service while executing the mash-up (S40), the mash-up service is terminated.

A service context inference engine unit 20 infers service context provided from the mash-up service in real time in link with an ontology management unit 60 while the mash-up service is executed (S50).

Thereafter, a mash-up management control unit 30 determines changes in a service context of the mash-up service in accordance with an inference result (S60).

At step S60, when the context of the mash-up service is changed in the inference result (S60; Y), the mash-up management control unit 30 reorganizes the configuration of the mash-up service (S70). In addition, the mash-up execution unit 10 executes the reorganized mash-up service again (S20).

FIG. 4 is a diagram showing one example of reorganizing a mash-up service of FIG. 3.

Referring to FIG. 4, first, the service context inference engine unit 20 infers the changes in the service context of the mash-up service (S100) while the mash-up execution unit 10 executes the mash-up service.

In this case, when the mash-up management control unit 30 determines that a new service should be added in accordance with a service context inference result (S110; Y), the mash-up management control unit 30 retrieves a service by using service metadata of a service registration DB 300 through a service retrieval unit 40 (S130) and thereafter, automatically generates a new service by combining the retrieved service with the existing service (S150). In addition, the newly generated mash-up service is provided to the mash-up user terminal 100 by the mash-up execution unit 10 (S160). Like this, the user who uses the mash-up service receives the new mash-up service automatically generated by the mash-up apparatus 400.

Meanwhile, at step S110, when the mash-up management control unit 30 does not determine that the new service should be added (S110; N), the mash-up management control unit 30 determines whether or not some of services included in the current service needs to be excluded in accordance with the service context inference result of the mash-up service (S120).

At step S120, when the mash-up management control unit 30 determines that some of the services need to be excluded in accordance with the inference result (S120; Y), the mash-up management control unit 30 deletes the corresponding service and automatically generates the new service (S150). In addition, the newly generated mash-up service is provided to the mash-up user terminal 100 by the mash-up execution unit 10 (S160). Like this, the user who uses the mash-up service receives the new mash-up service automatically generated by the mash-up apparatus 400.

Meanwhile, at step S120, when the mash-up management control unit 30 determines that some of the services need not to be excluded in accordance with the inference result (S120; N), the initially set mash-up service is provided to the mash-up user terminal 100 by the mash-up execution unit 10.

Steps S100 to S160 described above are repeated until the mash-up user terminal 100 terminates the mash-up service. In addition, the mash-up apparatus automatically generates and provides the new service in real time by continuously inferring the service context of the mash-up service.

FIG. 5 is a diagram showing a use example of a mash-up method according to an exemplary embodiment of the present invention.

The mash-up user terminal 100 accesses the mash-up apparatus 400 and defines the mash-up service by using an open API of a map service provider 311 and an open API provided by an odor sensor data provider 312 by using the edition tool unit 50.

Next, the mash-up execution unit 10 of the mash-up apparatus 400 receives odor sensor data from the odor sensor data provider 312, and overlaps and renders a map received from the map service provider 311 to provide a user's defined initial mash-up result 320.

Thereafter, the service context inference engine unit 20 of the mash-up apparatus 400 continuously infers a situation by using sensor data received from the odor sensor data provider 312 and map data provided from the map service provider 311.

The mash-up management control unit 30 of the mash-up apparatus 400 utilizes the service metadata of the service registration DB 300 through the service retrieval unit 40 in accordance with an inference result to reorganize the mash-up service by automatically retrieving a meteorological observation sensor data provider 331 as necessary. As a result, the mash-up execution unit 10 provides a new mash-up service as a first automatic mash-up result 330.

Accordingly, the mash-up user is automatically provided with a new extended mash-up service without defining a new mash-up service.

Further, when a situation where the mash-up apparatus services the first automatic mash-up result 330 is similar to a situation where the mash-up apparatus provides the mash-up service initially defined by the mash-up user, the mash-up apparatus is automatically disconnected from the meteorological observation sensor data provider 331 and may provide the user's defined initial mash-up result.

Such a process may be automatically repeated several times depending on the service context.

Further, the mash-up apparatus 400 monitors changes in a service context even after generating the first automatic mash-up result 330 by automatically retrieving the meteorological observation sensor data provider 331 depending on the service context of the user's defined initial mash-up result 320. In addition, the mash-up apparatus 400 may generate a secondary automatic mash-up result 340 by automatically retrieving another service provided by an analysis model provider when service context is changed.

As described above, according to the present invention, in providing the mash-up service initially defined by the mash-up user, a mash-up server may automatically provide a new mash-up service to the user by automatically retrieving and adding new resources or excluding unnecessary resources as necessary by inferring the service context of the user's defined mash-up result.

As a result, the mash-up user may be provided with new mash-up service without directly defining it.

Below, another example of the mash-up method shown in FIG. 5 will be described. In the description, similar parts of the example will not be described.

First, it is assumed that a map service provider, a position-based odor sensor data provider, a position-based meteorological information provider, an odor causing company information provider (for example, including odor components primarily produced by a factory in an industrial area and positional information of the factory), etc., in addition to various other services are registered in a service registration DB 300. Further, it is assumed that ontology relating to an odor management service is constructed.

A mash-up user initially defines a mash-up service rendering odor sensor data at a position on a map where an odor sensor is installed using open APIs provided by a map service provider and an odor sensor data provider. That is, the mash-up user initially defines the mash-up service by combining two external service providers, the map service provider and the odor sensor data provider with each other. A mash-up apparatus 400 combines data requested by the user from the map service provider and the odor sensor data provider and provides them.

The mash-up apparatus 400 continuously infers service context on the basis of ontology predefined from the data provided from the map service provider and the odor sensor data provider while providing a mash-up result service. For example, the most important service context is a case in which odor intensity is higher than a threshold value. The mash-up apparatus 400 infers the odor intensity by using an odor sensor value provided from the odor sensor data while providing the mash-up service initially defined by the mash-up user. In addition, the mash-up apparatus 400 infers that an odor is greatly influenced by meteorological information on the basis of the odor management ontology when the odor intensity is higher than the threshold value.

The mash-up apparatus 400 retrieves the position-based meteorological information provider providing the meteorological information that influences a point where the odor intensity is higher than the threshold value among the services registered in the service registration DB 300 on the basis of the inference result. In addition, the mash-up apparatus 400 mashes up the meteorological information using an open API provided by the position-based meteorological information provider and automatically provides the corresponding meteorological information to the user. Accordingly, at this time, the mash-up user receives the position-based meteorological information which the mash-up apparatus 400 automatically provides by inferring the service context in addition to two services of the map service provider and the position-based odor sensor data, which have been initially defined.

Further, in the case of a complex sensor that provides individual intensity of materials causing odor, the mash-up apparatus 400 combines the odor sensor data with the meteorological information using the individual intensity of materials and the open API provided by company information provides causing odor so as to infer the position of the company causing the odor at a point where odor sensor data is provided.

Next, the mash-up apparatus 400 provides the company information causing odor to the mash-up user on the bases of position as the inference result. Accordingly, at this time, the mash-up user is provided with the mash-up service extended by combining two services which the mash-up service provides by automatically inferring the service context in addition to two services which have been initially defined.

Further, the mash-up apparatus 400 continuously infers the odor intensity from the odor sensor data and when the odor intensity is lower than the threshold value, the mash-up apparatus 400 dynamically provides two initial services defined by the user by deleting the position-based meteorological information and company information causing odor which are automatically provided.

Such a process is continuously repeated while the mash-up service is provided. That is, the mash-up apparatus 400 infers the service context using the sensor value provided by the odor sensor data, and retrieves necessary services and provides them to the mash-up user by automatically including or excluding the mash-up service in accordance with an inference result. Accordingly, the mash-up user is dynamically provided with a new mash-up service automatically provided by the mash-up apparatus 400 without redefining a new mash-up service depending on the service context.

While the present invention has been shown and described in connection with the exemplary embodiments, it will be apparent to those skilled in the art that modifications and variations can be made without departing from the spirit and scope of the invention as defined by the appended claims.

What is claimed is:

1. An automatic mash-up apparatus, comprising:
a mash-up execution unit executing a mash-up service comprised of two or more open applications;
a service context inference engine unit inferring changes in a service context of the mash-up service; and
a mash-up management control unit reorganizing the mash-up service in accordance with an inference result of the service context inference engine unit.

2. The automatic mash-up apparatus according to claim 1, wherein the mash-up management control unit adds the corresponding service by using service metadata corresponding to each of the open applications when adding a new service to the mash-up service.

3. The automatic mash-up apparatus according to claim 2, further comprising a service retrieval unit retrieving the open applications corresponding to the service metadata,
wherein the mash-up management control unit adds the corresponding open application retrieved through the service retrieval unit when adding a new service to the mash-up service.

4. The automatic mash-up apparatus according to claim 3, wherein the mash-up management control unit deletes the corresponding open application when deleting the service from the mash-up service.

5. The automatic mash-up apparatus according to claim 4, further comprising:
an ontology management unit managing ontology of the mash-up service; and
an edition tool unit editing configuration of the mash-up service in link with the ontology management unit,
wherein the mash-up execution unit executes the mash-up service by combining the open applications on the basis of an edition result of the edition tool unit.

6. The automatic mash-up apparatus according to claim 5, wherein the mash-up execution unit provides an execution result of the mash-up service.

7. The automatic mash-up apparatus according to claim 2, further comprising an ontology management unit managing ontology of the mash-up service,
wherein the service context inference engine unit infers the changes in the service context on the basis of the execution result of the mash-up service in link with the ontology management unit while the mash-up service is executed.

8. The automatic mash-up apparatus according to claim 7, wherein the service metadata includes additional information for retrieving the open application by using semantic information on the basis of the ontology and connection information for calling the open application.

9. The automatic mash-up apparatus according to claim 8, wherein the service metadata is registered in a service registration datbase (DB) by a service provider terminal.

10. The automatic mash-up apparatus according to claim 2, wherein the mash-up execution unit receives a request for the mash-up service from a mash-up user terminal.

11. An automatic mash-up method, comprising:
executing a mash-up service comprised of two or more open applications;
inferring changes in a service context of the mash-up service; and
reorganizing the mash-up service in accordance with the changes in the service context.

12. The automatic mash-up method according to claim 11, wherein the reorganizing of the mash-up service adds the corresponding service by using service metadata corresponding to each of the open applications when adding a new service to the mash-up service.

13. The automatic mash-up method according to claim 12, further comprising retrieving open applications corresponding to the service metadata,
wherein the reorganizing of the mash-up service adds the corresponding open application retrieved through the retrieving when adding a new service to the mash-up service.

14. The automatic mash-up method according to claim 13, wherein the reorganizing of the mash-up service deletes the corresponding open application when deleting the service from the mash-up service.

15. The automatic mash-up method according to claim 14, further comprising editing configuration of the mash-up service in link with ontology,
wherein the executing of the mash-up service executes the mash-up service by combining the open applications on the basis of an edition result of the editing.

16. The automatic mash-up method according to claim 15, wherein the executing of the mash-up service provides an execution result of the mash-up service.

17. The automatic mash-up method according to claim 12, further comprising managing the ontology of the mash-up service,
wherein the inferring of the changes in the service context infers the changes in the service context on the basis of the execution result of the mash-up service in link with the ontology of the managing of the ontology while the mash-up service is executed.

18. The automatic mash-up method according to claim 17, wherein the service metadata includes additional information for retrieving the open application by using semantic information on the basis of the ontology and connection information for calling the open application.

19. The automatic mash-up method according to claim 18, wherein the service metadata is registered in a service registration database (DB) by a service provider terminal.

20. The automatic mash-up method according to claim 12, wherein the executing of the mash-up service receives a request for the mash-up service from a mash-up user terminal.
